(19) United States
(12) Patent Application Publication
(10) Pub. No.: US 2019/0243275 A1
(43) Pub. Date: Aug. 8, 2019

(54) INFORMATION PROCESSING APPARATUS THAT CORRECTS IMAGE DATA, AND IMAGE FORMING APPARATUS

(71) Applicant: CANON KABUSHIKI KAISHA, Tokyo (JP)

(72) Inventor: Shoji Takeda, Tokyo (JP)

(21) Appl. No.: 16/257,659

(22) Filed: Jan. 25, 2019

(30) Foreign Application Priority Data
Feb. 5, 2018 (JP) 2018-018518

(51) Int. Cl. G03G 15/043; G02B 26/12; G03G 15/04

(52) U.S. Cl. CPC G03G 15/043; G03G 15/04072; G02B 26/12

(57) ABSTRACT

The information processing apparatus includes: a detector configured to detect a change in a predetermined signal; and a specifier configured to specify a reflective surface used to scan a photosensitive member, based on a timing at which the change is detected. The detector is further configured to, in a period until specifying the reflective surface, detect the change after a predetermined amount of time has passed after the change has been detected, and after specifying the reflective surface, detect the change after an amount of time based on the specified reflective surface has passed after the change has been detected.

### BACKGROUND OF THE INVENTION

### Field of the Invention

The present invention relates to an information processing apparatus that corrects image data, and to an image forming apparatus including the information processing apparatus.

### Description of the Related Art

An electrophotographic image forming apparatus forms an electrostatic latent image on a photosensitive member by using an exposure apparatus to expose the photosensitive member that is charged. The exposure apparatus scans the photosensitive member by rotating a polygon mirror to deflect light from a light source. A beam detect (BD) sensor that detects light upstream from the photosensitive member is arranged along the scanning direction of the light (a main scanning direction). The BD sensor outputs a main scanning synchronization signal (BD signal) indicating the timing at which the light has been detected, and determines the timing at which the electrostatic latent image is written onto the photosensitive member with light on the basis of the BD signal.

If noise intermixes with the BD signal, the position in the main scanning direction may shift and produce distortion in the image to be formed. Japanese Patent Laid-Open No. 2017-37260 discloses a configuration that provides an interval, after the BD signal is detected, where the BD signal is not recognized for a predetermined period, which results in the intermixing noise being cut during that interval. The predetermined period is set on the basis of, for example, the shortest scanning period among scanning periods corresponding to a plurality of reflective surfaces. Specifically, an amount of time equivalent to 90% of the shortest scanning period is set as the predetermined period, for example.

The shapes of the surfaces of the polygon mirror that deflects the light differ from surface to surface. When the shapes of the surfaces differ from surface to surface, the amount of time from when the BD signal falls to when the BD signal falls for the first time after the stated fall (that is, the scanning period) differs for each reflective surface of the polygon mirror. If the predetermined period, that is, the period in which the BD signal is not recognized, is set as described in Japanese Patent Laid-Open No. 2017-37260, the period when the BD signal is not recognized in the longest scanning period, among the scanning periods corresponding to the plurality of reflective surfaces, will be shorter than a time equivalent to 90% of that longest scanning period. As a result, when detecting the fall of the BD signal, an erroneous detection may occur due to noise contained in the BD signal. The image that is formed may become distorted as a result.

### SUMMARY OF THE INVENTION

According to an aspect of the present invention, an information processing apparatus connected with an image forming apparatus including an image forming unit is provided. The image forming unit includes a first receiver configured to receive image data; a photosensitive member; a light source configured to emit light based on the image data received by the first receiver; a rotating polygonal mirror, having a plurality of reflective surfaces that reflect the light emitted by the light source, configured to scan the photosensitive member by being rotationally driven to deflect the light; and a light-receiving unit configured to receive the light reflected by the rotating polygonal mirror and output a predetermined signal having a first level and a second level in response to a reception of the light. The information processing apparatus includes: a second receiver configured to receive the predetermined signal; a detector configured to detect a change from the first level to the second level in the predetermined signal received by the second receiver; a specifier configured to specify a reflective surface, among the plurality of reflective surfaces, used to scan the photosensitive member, based on a timing at which the change is detected by the detector; a corrector configured to correct image data corresponding to each of a plurality of scanning lines constituting an image equivalent to one surface's worth of a recording medium, using correction data corresponding to the reflective surface corresponding to each scanning line; and an output unit configured to output the image data corrected by the corrector to the image forming unit in response to the detector detecting the change. The detector is further configured to, in a period until the specifier specifies the reflective surface, detect the change after a predetermined amount of time has passed after the change has been detected, and after the specifier has specified the reflective surface, detect the change after an amount of time based on the specified reflective surface has passed after the change has been detected.

Further features of the present invention will become apparent from the following description of exemplary embodiments with reference to the attached drawings.

### BRIEF DESCRIPTION OF THE DRAWINGS

FIG. 1 is a schematic diagram illustrating an image forming apparatus according to an embodiment.

FIG. 2 is a diagram illustrating an image corresponding to one surface's worth of a recording medium.

FIG. 3 is a diagram illustrating the configuration of a laser scanner unit according to an embodiment.

FIGS. 4A and 4B are diagrams illustrating a process of specifying a surface by which a laser beam is deflected.

FIG. 5 is a flowchart illustrating processing by an engine control unit according to an embodiment.

FIG. 6 is a diagram illustrating BD periods for each of reflective surfaces according to an embodiment.

FIG. 7 is a diagram illustrating an amount of change in a BD period according to an embodiment.

FIG. 8 is a diagram illustrating a relationship between BD periods for each of reflective surfaces, and a BD masking signal, according to an embodiment.

FIG. 9 is a flowchart illustrating processing by an image control unit according to an embodiment.

FIG. 10 is a block diagram illustrating a receiving unit and a surface specifying unit according to an embodiment.

FIG. 11 is a diagram illustrating BD periods for each of reflective surfaces, and a BD masking signal, according to an embodiment.

FIG. 12 is a flowchart illustrating processing by an image control unit according to an embodiment.

### DESCRIPTION OF THE EMBODIMENTS

### First Embodiment

Hereinafter, preferred embodiments of the present invention will be described with reference to the drawings. It should be noted, however, that the shapes, relative dispositions, and so on of the constituent elements described in these embodiments are to be changed as appropriate depending on the configurations, conditions, and so on of the apparatus to which the invention is applied, and the scope of the invention is not intended to be limited to the embodiments described hereinafter.

Image Forming Operations

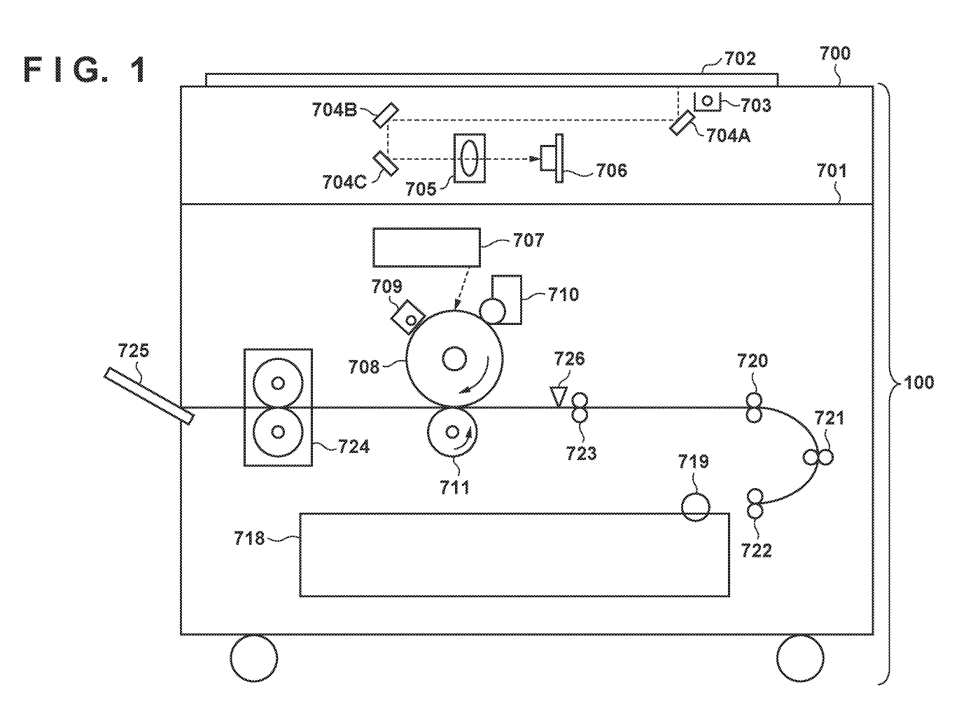

FIG. 1 is a cross-sectional view illustrating the configuration of a monochrome electrophotographic copier (called an “image forming apparatus” hereinafter) 100. Note that the image forming apparatus is not limited to a copier, and may be a facsimile device, a printer, or the like instead, for example. Additionally, the image forming apparatus may be either a monochrome type or a color type. The configuration and functions of the image forming apparatus 100 will be described hereinafter using FIG. 1. As illustrated in FIG. 1, the image forming apparatus 100 includes an image reading device (called a “reader” hereinafter) 700 and an image printing device 701.

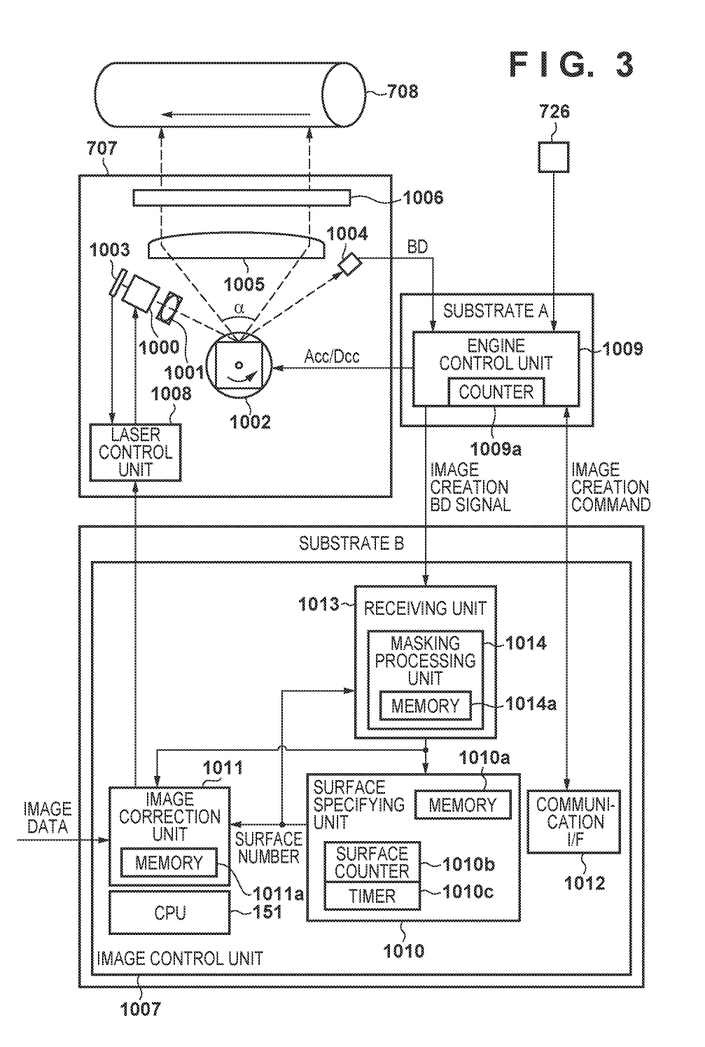

Light reflected by a document irradiated by an illumination lamp 703 at a reading position of the reader 700 is guided to a color sensor 706 by an optical system constituted by reflecting mirrors 704A, 704B, and 704C and a lens 705. The reader 700 reads each of the colors blue (“B”, hereinafter), green (“G”, hereinafter), and red (“R”, hereinafter) of the light incident on the color sensor 706, and converts the light into electrical image signals. Furthermore, the reader 700 obtains image data by carrying out a color conversion process on the basis of the intensities of the B, G, and R image signals, and outputs that image data to an image control unit 1007 (mentioned later; see FIG. 3).

A sheet holding tray 718 is provided within the image printing device 701. A recording medium held in the sheet holding tray 718 is fed out by a paper feed roller 719, and is conveyed to registration rollers 723, which are in a stopped state, by conveyance rollers 722, 721, and 720. A leading end of the recording medium conveyed by the conveyance rollers 720 in a conveyance direction contacts a nip part of the registration rollers that are in a stopped state. With the leading end of the recording medium in contact with the nip part of the registration rollers 723 that are in a stopped state, the conveyance rollers 720 convey the recording medium even further, which causes the recording medium to flex. As a result, elastic force acts on the recording medium, and the leading end of the recording medium makes contact along the nip part of the registration rollers 723. This corrects skew in the recording medium. After the skew in the recording medium has been corrected, the registration rollers 723 begin conveyance of the recording medium at a timing that will be described later. Note that the recording medium is any medium on which an image can be formed by the image forming apparatus, including paper, a resin sheet, cloth, an OHP sheet, a label, and the like, for example.

The image data obtained by the reader 700 is corrected by the image control unit 1007 and input to a laser scanner unit 707, which includes a laser and a polygon mirror. The outer circumferential surface of a photosensitive drum 708 is charged by a charger 709. After the outer circumferential surface of the photosensitive drum 708 has been charged, the outer circumferential surface of the photosensitive drum 708 is irradiated by the laser scanner unit 707 with a laser beam based on the image data input to the laser scanner unit 707. As a result, an electrostatic latent image is formed on a photosensitive layer covering the outer circumferential surface of the photosensitive drum 708 (a photosensitive member). Note that the configuration through which the electrostatic latent image is formed on the photosensitive layer by the laser beam will be described later.

Next, the electrostatic latent image is developed using toner within a developer 710, and a toner image is formed on the outer circumferential surface of the photosensitive drum 708. The toner image formed on the photosensitive drum 708 is transferred to the recording medium by a transfer charger 711 provided in a position opposite the photosensitive drum 708 (a transfer position). Note that the registration rollers 723 feed the recording medium to the transfer position in accordance with the timing at which the toner image is transferred to a predetermined position on the recording medium. The recording medium, onto which the toner image has been transferred as described above, is fed to a fixer 724, and the toner image is fixed onto the recording medium by being heated and pressed by the fixer 724. The recording medium onto which the toner image has been fixed is discharged to a discharge tray 725 outside the apparatus. An image is formed on the recording medium by the image forming apparatus 100 in this manner. The foregoing has described the configuration and functions of the image forming apparatus 100.

Configuration for Forming Electrostatic Latent Image

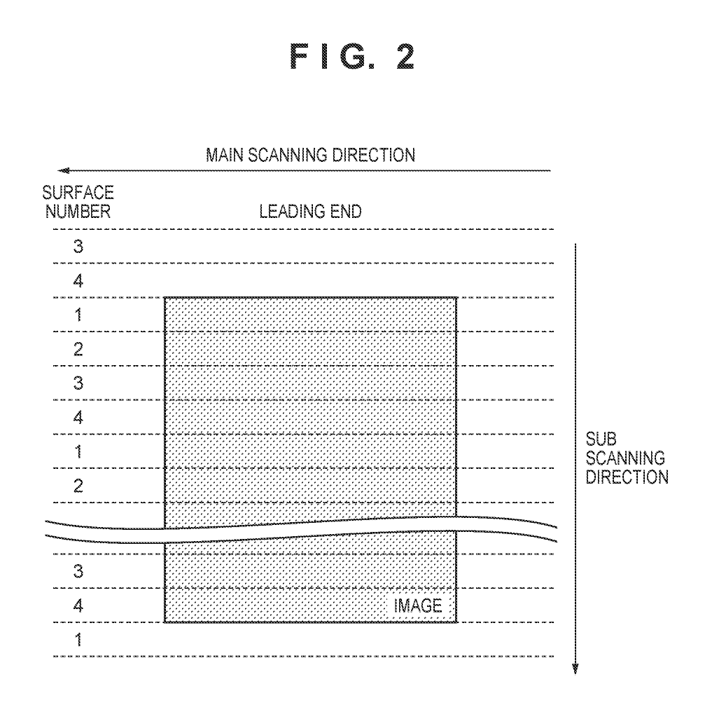

FIG. 2 is a diagram illustrating an image corresponding to one surface's worth of the recording medium. The surface numbers indicated in FIG. 2 are numbers indicating the respective reflective surfaces of a polygon mirror 1002, and in the present embodiment, the polygon mirror 1002 has four reflective surfaces. As illustrated in FIG. 2, one scan's worth (one line's worth) of an image (the electrostatic latent image) is formed on the photosensitive layer by the laser beam deflected by one of the plurality of reflective surfaces of the polygon mirror 1002 scanning the photosensitive layer in an axial direction of the photosensitive drum 708 (the main scanning direction). One recording medium surface's worth of the electrostatic latent image is formed on the photosensitive layer by repeating the scanning of the laser beam deflected by the respective surfaces in a rotation direction of the photosensitive drum 708 (a sub scanning direction). In the following descriptions, the data of an image corresponding to one line's worth of an electrostatic latent image will be called “image data”.

Optical Scanning Device

FIG. 3 is a block diagram illustrating the configuration of the laser scanner unit 707 according to the present embodiment. The configuration of the laser scanner unit 707 will be described hereinafter. As illustrated in FIG. 3, in the present embodiment, a substrate A on which an engine control unit 1009 is provided is a different substrate from a substrate B on which the image control unit 1007 is provided. The substrate A on which the engine control unit 1009 is provided is connected to the substrate B on which the image control unit 1007 is provided by a cable.

As illustrated in FIG. 3, laser beams are emitted from both ends of a laser light source 1000. The laser beam emitted from one end of the laser light source 1000 is incident on a photodiode 1003. The photodiode (PD) 1003 converts the incident laser beam into an electrical signal and outputs that signal to a laser control unit 1008 as a PD signal. On the basis of the input PD signal, the laser control unit 1008 controls the output light amount of the laser light source 1000 (Auto Power Control; called “APC” hereinafter) so that the output light amount of the laser light source 1000 becomes a predetermined light amount.

On the other hand, the laser beam emitted from the other end of the laser light source 1000 passes through a collimator lens 1001 and irradiates the polygon mirror 1002, which is a rotating polygonal mirror. The polygon mirror 1002 is rotationally driven by a polygon motor (not shown). The polygon motor is controlled by a drive signal (Acc/Dec) output from the engine control unit 1009. The laser beam with which the rotating polygon mirror 1002 is irradiated is deflected by the polygon mirror 1002. The scanning of the outer circumferential surface of the photosensitive drum 708 by the laser beam deflected by the polygon mirror 1002 progresses from the right to the left in FIG. 3. The laser beam scanning the outer circumferential surface of the photosensitive drum 708 is corrected by an F-θ lens 1005 so as to scan the outer circumferential surface of the photosensitive drum 708 at a uniform speed, and irradiates the outer circumferential surface of the photosensitive drum 708 through a folding mirror 1006.

The laser beam deflected by the polygon mirror 1002 is incident on a beam detect (BD) sensor 1004, which functions as a light-receiving unit including a light-receiving element that receives the laser beam. In the present embodiment, the BD sensor 1004 is disposed at a position that ensures that the outer circumferential surface of the photosensitive drum 708 is irradiated by the laser beam after the BD sensor 1004 has detected the laser beam, in a period spanning from when the BD sensor 1004 detects the laser beam to when the BD sensor 1004 detects the laser beam again. Specifically, the BD sensor 1004 is disposed, for example, in a part of the region through which the laser beam reflected by the polygon mirror 1002 passes which is outside a region indicated by an angle α and which is on the upstream side in the direction of the scanning by the laser beam, as illustrated in FIG. 3.

The BD sensor 1004 generates the BD signal on the basis of the detected laser beam and outputs the generated signal to the engine control unit 1009. On the basis of the input BD signal, the engine control unit 1009 controls the polygon motor so that a rotation period of the polygon mirror 1002 matches a predetermined period. The engine control unit 1009 determines that the rotation period of the polygon mirror 1002 matches the predetermined period when the period of the BD signal becomes a period corresponding to the predetermined period.

The engine control unit 1009 outputs an image creation BD signal (a timing signal) to the image control unit 1007 in accordance with the input BD signal. The image creation BD signal is a signal synchronized with the BD signal, and corresponds to a signal indicating one scanning period in which the laser beam scans the photosensitive drum 708. The image control unit 1007 outputs corrected image data to the laser control unit 1008 in accordance with the input image creation BD signal. Note that the detailed control configurations of the engine control unit 1009 and the image control unit 1007 will be described later.

The laser control unit 1008 causes the laser light source 1000 to light up on the basis of the input image data, thus generating the laser beam for forming an image on the outer circumferential surface of the photosensitive drum 708. In this manner, the laser control unit 1008 is controlled by the image control unit 1007, which is an information processing apparatus. The outer circumferential surface of the photosensitive drum 708 is irradiated with the generated laser beam through the above-described method.

A distance L from the position where a sheet sensor 726 detects the recording medium to the transfer position is longer than a distance x from the position on the outer circumferential surface of the photosensitive drum 708 irradiated by the laser beam to the transfer position with respect to the rotation direction of the photosensitive drum 708. Specifically, the distance L is a distance obtained by adding, to the distance x, a distance by which the recording medium is conveyed during a period spanning from when the sheet sensor 726 detects the leading end of the recording medium to when the laser beam is emitted from the laser light source 1000. Note that image data correction is carried out by the image control unit 1007, the laser control unit 1008 is controlled by the image control unit 1007, and so on in the period spanning from when the sheet sensor 726 detects the leading end of the recording medium to when the laser beam is emitted from the laser light source 1000. The foregoing has been a description of the configuration of the optical scanning device.

Method for Specifying Polygon Mirror Surface

The image control unit 1007 outputs the corrected image data to the laser control unit 1008, in order from the image data furthest upstream in the sub scanning direction, in accordance with the period of the image creation BD signal that has been input. The laser control unit 1008 forms an image on the outer circumferential surface of the photosensitive drum 708 by controlling the laser light source 1000 in accordance with the input image data. Although the polygon mirror 1002 has four surfaces in the present embodiment, it should be noted that the number of surfaces in the polygon mirror 1002 is not limited to four.

The image formed on the recording medium is formed by the laser beam deflected by the plurality of reflective surfaces of the polygon mirror 1002. Specifically, as illustrated in FIG. 2, an image corresponding to the image data furthest upstream in the sub scanning direction is formed by the laser beam deflected by a first surface of the polygon mirror 1002, for example. An image corresponding to the image data second-furthest upstream in the sub scanning direction is formed by the laser beam deflected by a second surface of the polygon mirror 1002, which is different from the first surface. In this manner, the image formed on the recording medium is constituted by images formed by the laser beam deflected by corresponding ones of the plurality of reflective surfaces of the polygon mirror 1002.

When a polygon mirror having four reflective surfaces is used as the polygon mirror for deflecting the laser beam, the angle formed by two adjacent reflective surfaces of the polygon mirror 1002 may not be a perfect 90° angle. Specifically, viewed from the rotation axis direction of the polygon mirror having four reflective surfaces, the angle formed by two adjacent sides may not be a perfect 90° angle (that is, the shape of the polygon mirror as viewed from the rotation axis direction may not be a perfect square). Note that when a polygon mirror having n reflective surfaces (where n is a positive integer) is used, the shape of the polygon mirror as viewed from the rotation axis direction may not be a perfect n-sided polygon.

When a polygon mirror having four reflective surfaces is used, and the angle formed by two adjacent reflective surfaces of the polygon mirror is not a perfect 90° angle, the position, size, and so on of the image formed by the laser beam will differ from reflective surface to reflective surface. As a result, the image formed on the outer circumferential surface of the photosensitive drum 708 will become distorted, and distortion will also arise in the image formed on the recording medium.

Accordingly, in the present embodiment, the image data is corrected (writing position correction or the like) on the basis of a correction amount (correction data) corresponding to each of the plurality of reflective surfaces of the polygon mirror 1002. In this case, it is necessary to provide a configuration for specifying the surface by which the laser beam is deflected. An example of a method for specifying the surface by which the laser beam is deflected will be described hereinafter. In the present embodiment, a surface specifying unit 1010 provided in the image control unit 1007 specifies the surface, among the plurality of reflective surfaces of the polygon mirror 1002, that deflects (reflects) the laser beam.

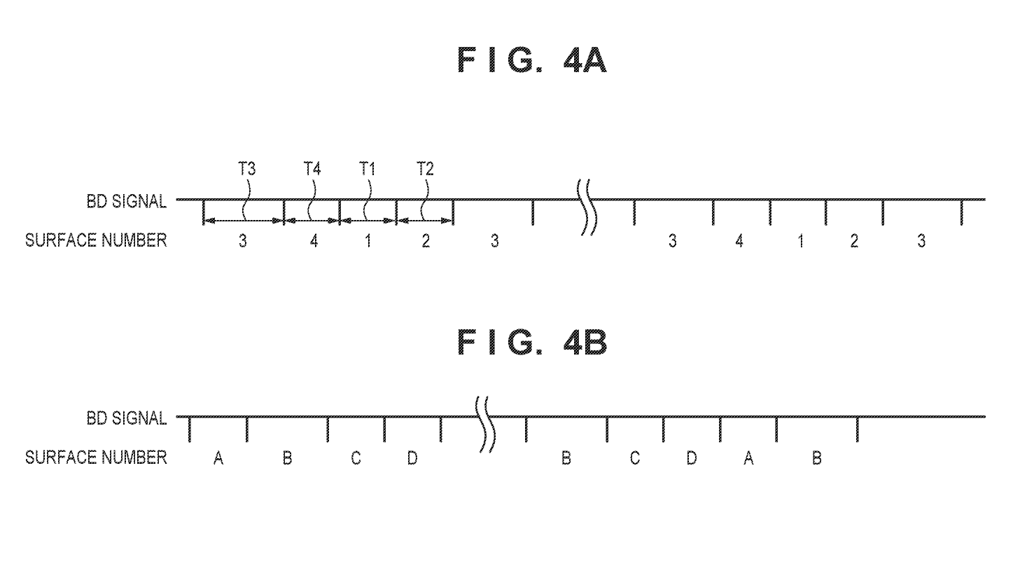

FIG. 4A is a diagram illustrating an example of a relationship between the BD signal generated by the laser beam scanning a light-receiving surface of the BD sensor 1004, and the surface (surface number) that deflects that laser beam. As illustrated in FIG. 4A, a change in the pulses of the BD signal, which in this example is the amount of time from when the BD signal falls to the first time the BD signal falls again after the stated fall (the scanning period), differs depending on the surface of the polygon mirror 1002. In other words, the period between the falls of two pulses of the BD signal that are sequential in terms of time is not constant. Note that the scanning period corresponds to an amount of time spanning from when the laser beam scans the light-receiving surface of the BD sensor 1004, to the first time the laser beam scans the light-receiving surface again after the stated instance of the laser beam scanning the light-receiving surface.

In FIG. 4A, the period corresponding to surface number 1 is indicated by T1, the period corresponding to surface number 2 is indicated by T2, the period corresponding to surface number 3 is indicated by T3, and the period corresponding to surface number 4 is indicated by T4. Note that these periods are stored as period information in memory 1010a, which is provided in the surface specifying unit 1010.

The surface specifying unit 1010 specifies the surface by which the laser beam is deflected (the surface number) through the following method. Specifically, the surface specifying unit 1010 sets surface numbers A through D for four consecutive scanning periods of the BD signal, as illustrated in FIG. 4B. The surface specifying unit 1010 then measures the scanning periods multiple times (e.g., 32 times) for each of the surface numbers A through D, and calculates average values of the measured periods for each of the surface numbers A through D.

The surface specifying unit 1010 then specifies which of the surface numbers A through D correspond to the surface numbers 1 through 4 on the basis of the calculated periods and the periods T1 through T4 held in the memory 1010a. In this manner, the surface specifying unit 1010 specifies the number of the surface by which the laser beam is deflected (the reflective surface, among the plurality of reflective surfaces of the polygon mirror 1002, that is used to scan the photosensitive drum 708) on the basis of the BD signal that is input.

Engine Control Unit

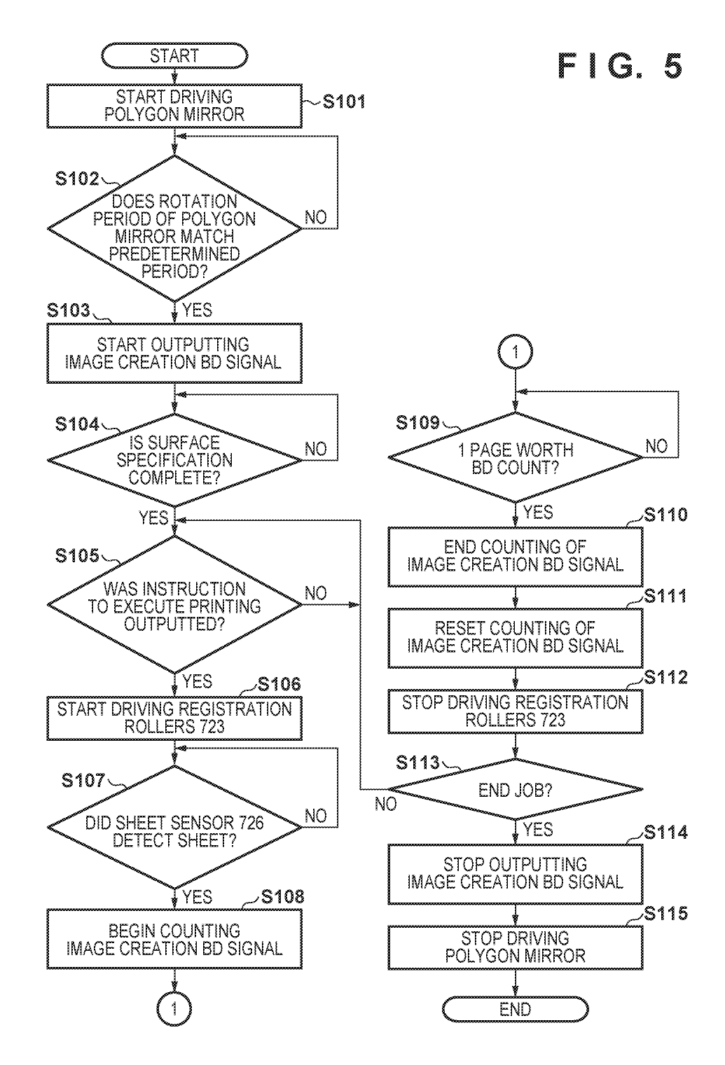

Control carried out by the engine control unit 1009 according to the present embodiment will be described next. FIG. 5 is a flowchart illustrating the control carried out by the engine control unit 1009 according to the present embodiment. Note that the processing illustrated in the flowchart of FIG. 5 is executed by the engine control unit 1009.

When a print job is started, in S101, the engine control unit 1009 starts driving the motor (the polygon motor) that rotationally drives the polygon mirror 1002. Once the rotation period of the polygon mirror 1002 matches the predetermined period in S102, the engine control unit 1009 starts outputting the image creation BD signal in S103. Then, in S104, the engine control unit 1009 is notified by the image control unit 1007, via a communication I/F 1012, that the surface specifying process is complete, and the processing then moves to S105.

Then, in S105, an instruction to form an image on the recording medium (an instruction to execute printing) is output from the image control unit 1007 to the engine control unit 1009 via the communication I/F 1012. After this, in S106, the engine control unit 1009 starts driving the registration rollers 723. The conveyance of the recording medium starts as a result.

Then, in S107, a signal indicating that the sheet sensor 726 has detected the leading end of the recording medium is input to the engine control unit 1009. After this, in S108, the engine control unit 1009 begins counting the pulses of the image creation BD signal that has been output using a counter 1009a. Note that the engine control unit 1009 counts the falls of the pulses of the image creation BD signal that is output, for example.

When in S109 the number of counted pulses reaches a number of pulses corresponding to one sheet's worth of the recording medium, in S110, the engine control unit 1009 stops counting the pulses of the image creation BD signal that is output, and in S111, the engine control unit 1009 resets the count number.

Furthermore, in S112, the engine control unit 1009 stops driving the registration rollers 723. Then, in S113, if the print job is not to be ended, the processing returns to S105. On the other hand, if in S113 the print job is to be ended, the engine control unit 1009 stops the output of the image creation BD signal in S114, and in S115, the engine control unit 1009 stops driving the polygon mirror 1002 and ends the processing of this flowchart. The foregoing has been a description of the control carried out by the engine control unit 1009.

Image Control Unit

Control carried out by the image control unit 1007 will be described next. As illustrated in FIG. 3, the image control unit 1007 includes the surface specifying unit 1010, which specifies the reflective surface, among the plurality of reflective surfaces, by which the laser beam that scans the light-receiving surface of the BD sensor 1004 is deflected, and an image correction unit 1011 that corrects the image data on the basis of surface information pertaining to the reflective surface.

The surface specifying unit 1010 includes a timer 1010c that measures an amount of time spanning from when the pulse of the BD signal falls, to the first time the BD signal falls again after the stated fall of the BD signal. The surface specifying unit 1010 carries out the process of specifying the reflective surface through the above-described method on the basis of the measurement result from the timer 1010c and the periods T1 through T4 stored in the memory 1010a.

Additionally, the surface specifying unit 1010 includes a surface counter 1010b that stores information of the specified reflective surface. After specifying the reflective surface, the surface specifying unit 1010 updates the surface information in the surface counter each time the image creation BD signal is input (that is, each time the falling edge of the image creation BD signal is detected), and outputs that surface information.

Masking Processing Unit

The image creation BD signal input to the image control unit 1007 (or the falling edge of the image creation BD signal) is detected by a receiving unit 1013. The image creation BD signal may be erroneously detected if noise is intermixed with the image creation BD signal input to the image control unit 1007. Accordingly, in the present embodiment, the receiving unit 1013 is provided with a masking processing unit 1014 that carries out a masking process for the detection of the image creation BD signal, as illustrated in FIG. 3.

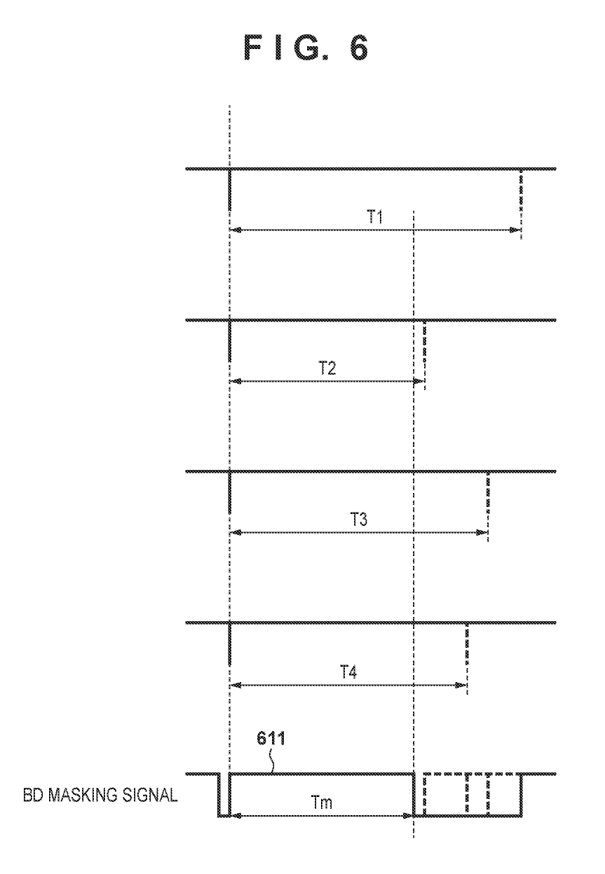

FIG. 6 is a diagram illustrating an example of the lengths of the scanning periods T1, T2, T3, and T4 for the respective reflective surfaces of the polygon mirror 1002. In FIG. 6, the positions of the starting points are aligned to make it easier to compare the lengths of the scanning periods T1, T2, T3, and T4 indicated by the image creation BD signal. A BD masking signal 611 indicated in FIG. 6 is a signal output from the masking processing unit 1014, and the detection of the image creation BD signal is masked during the period where the BD masking signal 611 is high. Although the receiving unit 1013 does not detect the image creation BD signal during the period where the BD masking signal 611 is high in the present embodiment, the present invention is not limited to such a configuration. For example, the configuration may be such that in the period where the BD masking signal 611 is high, the receiving unit 1013 does detect the image creation BD signal but the detection result is not output from the receiving unit 1013. Alternatively, for example, the configuration may be such that in the period in which the BD masking signal 611 is high, the receiving unit 1013 detects the image creation BD signal and outputs the detection result, but the surface specifying unit 1010 and the image correction unit 1011 ignore (do not employ) the detection result. In the present embodiment, when the falling edge of the image creation BD signal is detected by the receiving unit 1013, the masking processing unit 1014 switches the BD masking signal 611 from “L” (low level) to “H” (high level). A method of controlling the BD masking signal 611 by the masking processing unit 1014 will be described hereinafter.

In the present embodiment, during a period spanning until the surface specifying unit 1010 has successfully specified the surfaces, the masking processing unit 1014 sets the BD masking signal to “H” from when the falling edge of the image creation BD signal is detected by the receiving unit 1013 to when a predetermined amount of time Tm has passed. Note that the predetermined amount of time Tm is set on the basis of the shortest period among the scanning periods T1, T2, T3, and T4. Specifically, the predetermined amount of time Tm is an amount of time shorter than the shortest of the scanning periods T1, T2, T3, and T4 by a predetermined amount of time (margin), and is a pre-set amount of time. The predetermined amount of time Tm is stored in memory 1014a provided in the masking processing unit 1014.

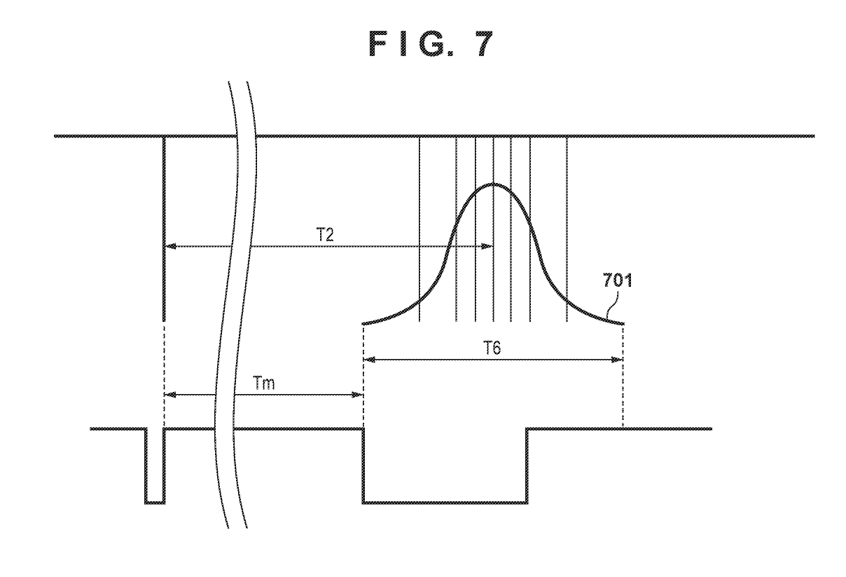

FIG. 7 is a diagram illustrating a method for setting the margin. Rotational unevenness of the polygon mirror 1002 causes variations to arise in the scanning periods of the respective reflective surfaces. FIG. 7 illustrates a distribution 701 obtained by measuring the period T2 of the second surface multiple times. A period T6 corresponds to a range of the distribution 701. The margin is set to half of T6, for example, and the amount of time Tm is set on the basis of the following Expression (1).

Tm=T2−T6/2 (1)

The descriptions given below will use the following as examples of specific numerical values: T1=313.7345 (μs); T2=312.9556 (μs); T3=313.3329 (μs); and T4=313.1770 (μs). As further specific examples of numerical values, the polygon mirror 1002 is assumed to rotate once in 313.3 (μs), and 10.4 (ns) of rotational unevenness can arise. The rotational unevenness of 10.4 (ns) is rotational unevenness for a single rotation of the polygon mirror 1002, and T6 is therefore 10.4 (ns). As such, according to Expression (1), Tm=312.9504 (μs).

Once the predetermined amount of time Tm has passed after the BD masking signal 611 has been set to “H”, the masking processing unit 1014 switches the BD masking signal 611 from “H” to “L”. In the above-described masking process, the amount of time Tm for which the BD masking signal 611 is “H” is set on the basis of the shortest period among the scanning periods T1, T2, T3, and T4. In this case, the amount of time for which the BD masking signal 611 is “L” becomes longer in the order of the second surface, the fourth surface, the third surface, and the first surface, as illustrated in FIG. 6. Specifically, for example, the BD detection period (i.e., the period for which the BD masking signal 611 is “L”) for the first surface is 313.7345 (μs)−312.9504 (μs)=784.1 (ns). The longer the period for which the BD masking signal 611 is “L” is, the more likely it becomes that the falling edge will be erroneously detected due to noise present in the image creation BD signal in that period. Accordingly, in the present embodiment, a situation in which the formed image is distorted is suppressed by using the following configuration.

As described above, the surface specifying unit 1010 outputs the surface information once the process for specifying the reflective surfaces is complete. As illustrated in FIG. 3, the surface information (surface numbers) output from the surface specifying unit 1010 is input to the receiving unit 1013 (the masking processing unit 1014).

On the basis of the surface information, the masking processing unit 1014 carries out the masking processes corresponding to the respective reflective surfaces. Specifically, a BD masking period Tmk for the kth surface (where k is 1 to 4) is set according to the following Expression (2).

Tmk=Tk−T6/2 (2)

Applying the aforementioned specific numerical values results in the following:

### Tm1=313.7293 (μs)

### Tm2=312.9504 (μs)

### Tm3=313.3277 (μs)

### Tm4=313.1718 (μs)

Note that Tm1, Tm2, Tm3, and Tm4 are pre-set values and are stored in the memory 1014a provided in the masking processing unit 1014.

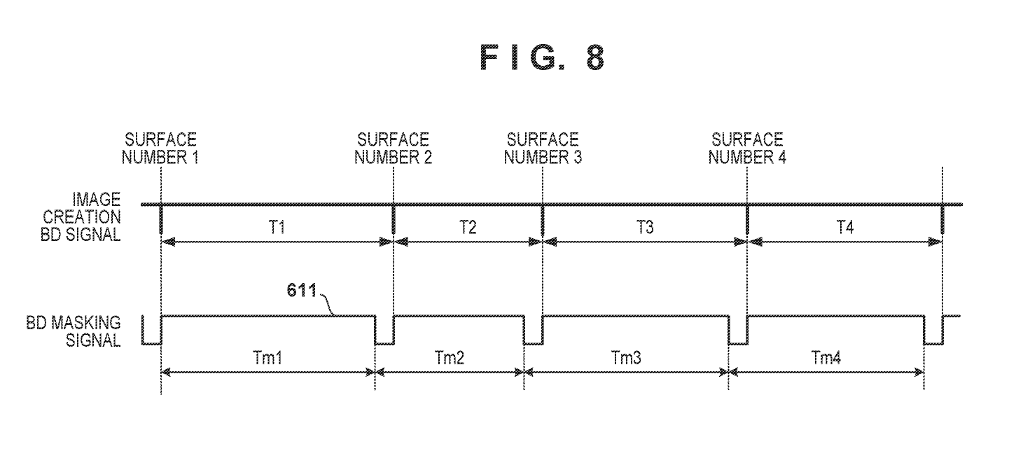

FIG. 8 illustrates a relationship between the image creation BD signal and the BD masking signal 611 after the reflective surfaces have been specified. The masking processing unit 1014 sets the BD masking signal 611 to “H” in response to the image creation BD signal reflected by the reflective surface having a surface number of 1 being detected. Then, once the period Tm1 has passed, the masking processing unit 1014 switches the BD masking signal 611 from “H” to “L”. The receiving unit 1013 detects the image creation BD signal as a result. Then, the masking processing unit 1014 sets the BD masking signal 611 to “H” for the period Tm2 in response to the image creation BD signal reflected by the reflective surface having a surface number of 2 being detected. Similar processing is repeated thereafter.

Image Data Correction

The image correction unit 1011 corrects the image data in order from image data A, which is the image data, among the plurality of pieces of data constituting one page's worth of an image as illustrated in FIG. 2, that is the furthest upstream in the sub scanning direction. Specifically, when, for example, the image corresponding to the image data A is an image formed by a laser beam deflected by the reflective surface corresponding to surface number 1, the image correction unit 1011 carries out correction corresponding to the surface number 1 on the image data A. To be more specific, the image correction unit 1011 reads out the correction data associated with surface number 1 from memory 1011a. The image correction unit 1011 then corrects the image data A on the basis of the read-out correction data. After this, the image correction unit 1011 corrects image data B, which is the image data, among the plurality of pieces of image data downstream from the image data A in the sub scanning direction, that is the furthest upstream, on the basis of the correction data, corresponding to surface number 2, that is stored in the memory 1011a. In this manner, the memory 1011a stores correction data corresponding to each of the surface numbers.

According to this configuration, the laser beam based on the image data corrected by the correction data corresponding to surface number “n” (where n is an integer from 1 to 4) is deflected by the reflective surface corresponding to the surface number “n”. The image correction unit 1011 carries out the above-described processing until the correction of the image data corresponding to one sheet of the recording medium is complete.

The image correction unit 1011 outputs the image data corrected on a region-by-region basis as described above to the laser control unit 1008 on a region-by-region basis, in order from the upstream side (i.e., from the image data A). Note that the image correction unit 1011 outputs a single piece of image data to the laser control unit 1008 each time the falling edge of the image creation BD signal is detected (i.e., in accordance with the period of the image creation BD signal). Although the image correction unit 1011 corrects the image data and outputs the corrected image data in synchronization with the image creation BD signal in the present embodiment, the configuration is not limited thereto. For example, the configuration may be such that the image correction unit 1011 corrects the image data in advance on the basis of the surface numbers from the surface counter 1010b, and outputs the pre-corrected image data to the laser control unit 1008 in synchronization with the image creation BD signal.

The image correction unit 1011 includes a counter (not shown) that counts the number of pieces of image data that have been output, and stops the output of the image data once the count of that counter reaches one sheet's worth (one page's worth) of the recording medium.

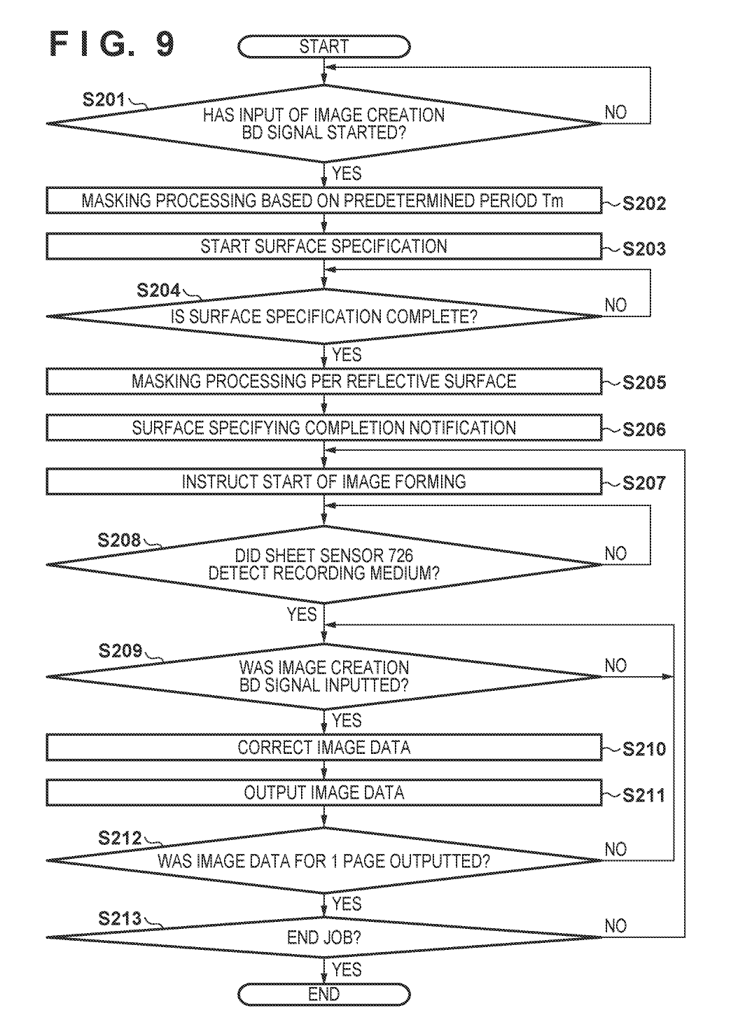

FIG. 9 is a flowchart illustrating control carried out by the image control unit 1007. Note that the processing of the flowchart illustrated in FIG. 9 is executed by a CPU 151. In the following descriptions, the surface number output to the image correction unit 1011 by the surface counter 1010b is updated each time the surface counter 1010b updates the surface number. Additionally, the image control unit 1007 (the image correction unit 1011) counts the number of regions of the output image data during the period where the flowchart illustrated in FIG. 9 is being executed.

After the input of the image creation BD signal from the engine control unit 1009 to the image control unit 1007 is started in S201, the process moves to S202. In S202, the CPU 151 controls the masking processing unit 1014 to set the BD masking signal 611 to “H” for the predetermined amount of time Tm following the detection of the falling edge by the receiving unit 1013. As a result, the masking process is carried out for the detection of the image creation BD signal for a period equivalent to the amount of time Tm.

Next, in S203, the CPU 151 controls the surface specifying unit 1010 to carry out the surface specifying process on the basis of the image creation BD signal. The surface specifying process by the surface specifying unit 1010 is started as a result. Once the surface specification of S204 is complete, in S205, the CPU 151 controls the masking processing unit 1014 to carry out the masking process on a reflective surface-by-reflective surface basis. As a result, the masking process is carried out for the detection of the image creation BD signal for a period equivalent to the amount of time Tmk, i.e., in accordance with the reflective surface. Then, in S206, the CPU 151 notifies the engine control unit 1009 that the surface specification is complete, via the communication I/F 1012.

Then, in S207, the CPU 151 outputs an instruction to form an image on the recording medium to the engine control unit 1009. As a result, the engine control unit 1009 starts driving the registration rollers 723. In S208, the engine control unit 1009 notifies the image control unit 1007 that the sheet sensor 726 has detected the leading end of the recording medium, after which the CPU 151 moves the processing to S209. Upon the image creation BD signal being input in S209, in S210, the CPU 151 controls the image correction unit 1011 to correct the image data on the basis of the surface number indicated by the surface counter 1010b. As a result, the image correction unit 1011 corrects the image data on the basis of the surface number indicated by the surface counter 1010b.

Then, in S211, the CPU 151 controls the image correction unit 1011 to output the image data, which has been corrected in S210, to the laser control unit 1008 in synchronization with the image creation BD signal. As a result, the corrected image data is output to the laser control unit 1008 in synchronization with the image creation BD signal. The image control unit 1007 repeats the processing for S209 to S211 until image data corresponding to one sheet (one page) of the recording medium is output. The CPU 151 repeats the above-described processing until the print job is complete.

In this manner, before a reflective surface has been specified, the masking process is carried out on the basis of the amount of time Tm, which is set on the basis of the shortest of the scanning periods T1, T2, T3, and T4; after the reflective surface has been specified, the masking process is carried out on the basis of the amount of time Tmk, which is set on the basis of the scanning period of that reflective surface. According to this configuration, the period for detecting the BD signal can be shortened, and thus erroneous detections of the image creation BD signal caused by noise can be suppressed. In other words, a situation where the formed image is distorted can be suppressed.

### Second Embodiment

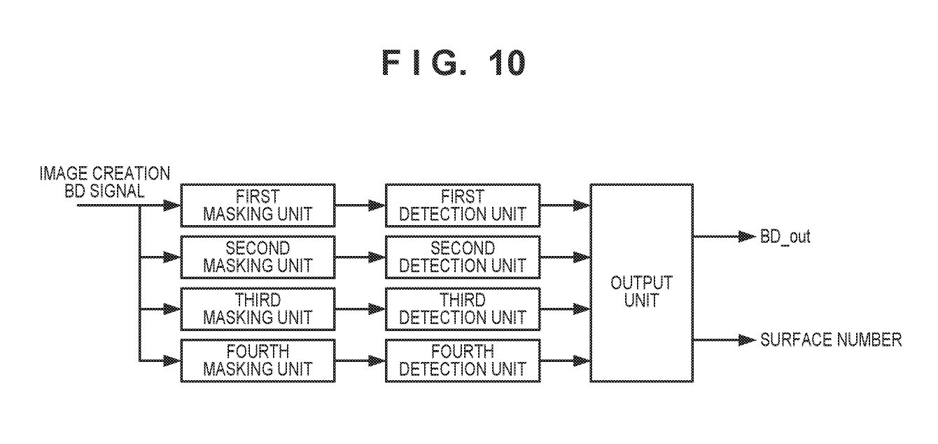

Parts of the configuration of the image forming apparatus that are the same as those in the first embodiment will not be described. In the first embodiment, a BD masking period is set in accordance with the minimum BD period up until the reflective surface that reflects the laser beam is specified. In the present embodiment, a detection unit corresponding to each reflective surface of the polygon mirror 1002 is provided, and the detection units detect the BD signal in parallel. FIG. 10 is a block diagram illustrating the receiving unit 1013 and the surface specifying unit 1010 according to the present embodiment. The polygon mirror 1002 according to the present embodiment has four reflective surfaces, and thus the receiving unit 1013 and the surface specifying unit 1010 include a first masking unit to a fourth masking unit, as well as a first detection unit to a fourth detection unit corresponding to the first masking unit to the fourth masking unit. The BD masking periods Tm1 to Tm4 described in the first embodiment are set for the first masking unit to the fourth masking unit, respectively. When the BD masking period Tm1 has passed, the first detection unit starts detecting the image creation BD signal. Likewise, when the BD masking period Tm2 has passed, the second detection unit starts detecting the image creation BD signal; when the BD masking period Tm3 has passed, the third detection unit starts detecting the image creation BD signal; and when the BD masking period Tm4 has passed, the fourth detection unit starts detecting the image creation BD signal. Note that in this example, the jitter period T6 is 10.4 (ns), and thus each detection unit detects the image creation BD signal for a period of 10.4 (ns). Each detection unit detects the image creation BD signal, rather than masking the detection of the image creation BD signal, during a period spanning from the start of laser beam emission to when the first image creation BD signal is detected.

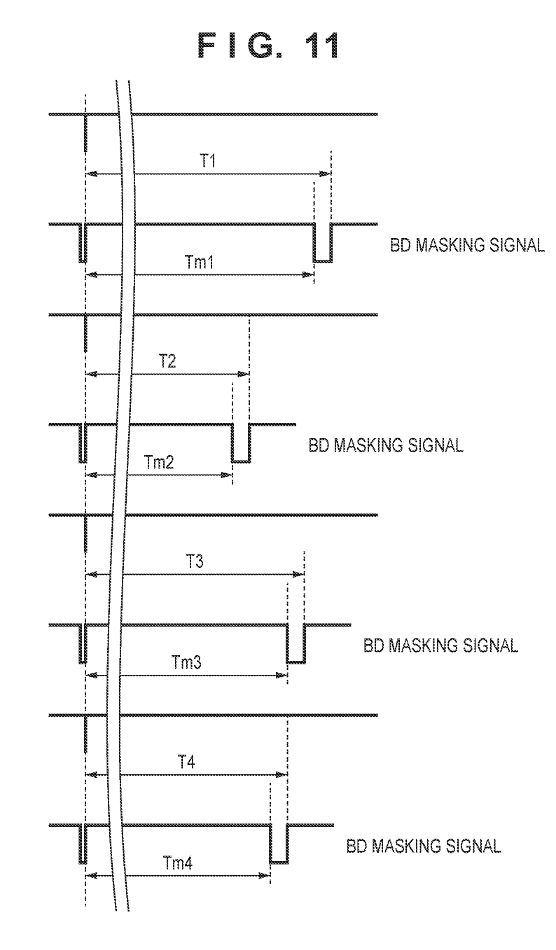

FIG. 11 illustrates a relationship between the BD periods and the BD masking period. For example, as is clear from FIG. 11, when the first surface is reflecting the laser beam, only the first detection unit detects the image creation BD signal, and when the second surface is reflecting the laser beam, only the second detection unit detects the image creation BD signal. Likewise, when the third surface is reflecting the laser beam, only the third detection unit detects the image creation BD signal, and when the fourth surface is reflecting the laser beam, only the fourth detection unit detects the image creation BD signal. When any one of the detection units detects the image creation BD signal, the detection units stop the detection of the image creation BD signal for the masking period set for the corresponding masking unit, and once the masking period has passed, the image creation BD signal is detected for the BD detection period, which in this example is T6=10.4 (ns). Accordingly, the reflective surface reflecting the laser beam can be specified by the detection unit that has detected the image creation BD signal. An output unit outputs the surface number specified in this manner and a detection timing BD_out of the image creation BD signal to the image correction unit 1011. Although the BD detection period is found from a jitter amount for a single rotation of the polygon mirror 1002 in this example, the present invention is not limited thereto, and the BD detection period may be set on the basis of variation in the BD period.

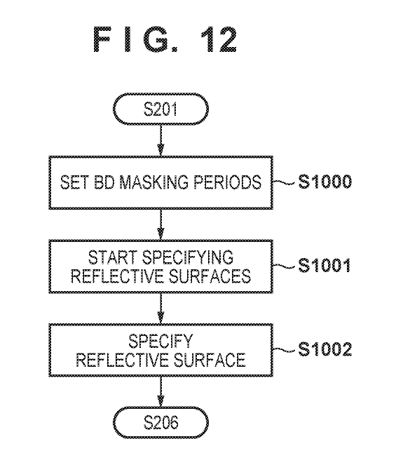

FIG. 12 is a flowchart illustrating control by the image control unit 1007 according to the present embodiment. Note that FIG. 12 illustrates only the parts different from the first embodiment illustrated in FIG. 9. In the present embodiment, the processes of S202 to S205 illustrated in FIG. 9 are replaced with the processes of S1000 to S1002. Upon the input of the image creation BD signal starting in S201, in S1000, the image control unit 1007 sets the masking periods Tm1 to Tm4 in the first masking unit to the fourth masking unit, respectively. In S1001, the image control unit 1007 starts specifying the reflective surfaces on the basis of the image creation BD signal. In S1002, the image control unit 1007 specifies the reflective surface on the basis of the detection results from the detection units as described above.

As indicated in FIG. 11, in this example, only one of the detection units detects the BD signal in the BD signal detection period. However, if, for example, there is only a small difference between the period T2 and the period T4 in FIG. 10, the second detection unit and the fourth detection unit can both detect the BD signal. In such a case, the reflective surface reflecting the laser beam can be determined by the detection unit that detects the next BD signal. In other words, if the third detection unit detects the next BD signal, it can be determined that the third surface is reflecting the laser beam, and thus the previous reflective surface can be determined to be the second surface. On the other hand, if the first detection unit detects the next BD signal, it can be determined that the first surface is reflecting the laser beam, and thus the previous reflective surface can be determined to be the fourth surface. Likewise, if there is only a small difference among three BD periods, but a large difference with the remaining BD period, the reflective surface can be specified by that one remaining BD period. As such, the polygon mirror 1002, which is an uneven-length polygon, can be configured so that the BD period corresponding to at least one reflective surface can be distinguished from the BD periods corresponding to the other reflective surfaces. For example, the polygon mirror 1002, which is an uneven-length polygon, can be configured so that the BD periods corresponding to all of the reflective surfaces are different.

According to the present embodiment, the time for detecting the BD signal after the reflective surface reflecting the laser beam has been specified can be shortened, which makes it possible to prevent erroneous operations caused by the intermixing of noise. Additionally, the reflective surface reflecting the laser beam can be specified by the detection units detecting the BD signal, which makes it possible to quickly specify the reflective surface.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-018518, filed on Feb. 5, 2018, which is hereby incorporated by reference herein in its entirety.

What is claimed is:

1. An information processing apparatus connected to an image forming apparatus including an image forming unit, the image forming unit comprising:
a first receiver configured to receive image data;
a photosensitive member;
a light source configured to emit light based on the image data received by the first receiver;
a rotating polygonal mirror, having a plurality of reflective surfaces that reflect the light emitted by the light source, configured to scan the photosensitive member by being rotationally driven to deflect the light; and
a light-receiving unit configured to receive the light reflected by the rotating polygonal mirror and output a predetermined signal having a first level and a second level in response to a reception of the light, and
the information processing apparatus comprising:
a second receiver configured to receive the predetermined signal;
a detector configured to detect a change from the first level to the second level in the predetermined signal received by the second receiver;
a specifier configured to specify a reflective surface, among the plurality of reflective surfaces, used to scan the photosensitive member, based on a timing at which the change is detected by the detector;
a corrector configured to correct image data corresponding to each of a plurality of scanning lines constituting an image equivalent to one surface's worth of a recording medium, using correction data corresponding to the reflective surface corresponding to each scanning line; and
an output unit configured to output the image data corrected by the corrector to the image forming unit in response to the detector detecting the change,
wherein the detector is further configured to, in a period until the specifier specifies the reflective surface, detect the change after a predetermined amount of time has passed after the change has been detected, and after the specifier has specified the reflective surface, detect the change after an amount of time based on the specified reflective surface has passed after the change has been detected.

2. The information processing apparatus according to claim 1,
wherein the detector is further configured to, in the period until the specifier specifies the reflective surface, not detect the change in a period from when the change is detected to when the predetermined amount of time has passed, and after the specifier has specified the reflective surface, not detect the change in a period from when the change is detected to when the amount of time based on the specified reflective surface has passed.

3. The information processing apparatus according to claim 1,
wherein the amount of time based on the specified reflective surface is set based on an amount of time from a first timing at which the change is detected by the detector to a second timing at which the change is detected by the detector for a first time after the first timing.

4. The information processing apparatus according to claim 3,
wherein the amount of time based on the specified reflective surface is set to an amount of time obtained by subtracting a predetermined margin from the amount of time from the first timing to the second timing.

5. The information processing apparatus according to claim 4,
wherein the predetermined margin is set based on a jitter amount in a rotation of the rotating polygonal mirror.

6. The information processing apparatus according to claim 1,
wherein the predetermined amount of time is set based on the shortest amount of time among scanning times corresponding to respective ones of the reflective surfaces of the rotating polygonal mirror.

7. The information processing apparatus according to claim 1,
wherein the specifier is further configured to specify the reflective surface used to scan the photosensitive member based on an amount of time from a first timing at which the change is detected by the detector to a second timing at which the change is detected by the detector for a first time after the first timing.

8. An information processing apparatus connected to an image forming apparatus including an image forming unit, the image forming unit comprising:
a first receiver configured to receive image data;
a photosensitive member;
a light source configured to emit light based on the image data received by the first receiver;
a rotating polygonal mirror, having a plurality of reflective surfaces that reflect the light emitted by the light source, configured to scan the photosensitive member by being rotationally driven to deflect the light; and
a light-receiving unit configured to receive the light reflected by the rotating polygonal mirror and output a timing signal indicating a timing at which the light is received, and
the information processing apparatus comprising:
a second receiver configured to receive the timing signal;
a detector configured to detect the timing indicated by the timing signal;
a holding unit configured to hold period information indicating a period based on each of the plurality of reflective surfaces, the period based on a reflective surface being a period from when the light reflected by the reflective surface is received by the light-receiving unit to when the light reflected by the next reflective surface is received by the light-receiving unit;
a specifier configured to specify the reflective surface, among the plurality of reflective surfaces, used to scan the photosensitive member;
a corrector configured to correct image data corresponding to each of a plurality of scanning lines constituting an image equivalent to one surface's worth of a recording medium, using correction data corresponding to the reflective surface corresponding to each scanning line; and
an output unit configured to output the image data corrected by the corrector to the image forming unit in response to the detector detecting the timing,
wherein the detector is further configured to mask a detection of the timing signal during a masking period following the detection of the timing; and
the detector is further configured to, after the specifier has specified the reflective surface used to scan the photosensitive member, set the masking period, when the detector has detected the timing indicating that the light-receiving unit has received the light reflected by the reflective surface specified by the specifier, based on a period corresponding to the reflective surface specified by the specifier.

9. The information processing apparatus according to claim 8,
wherein the detector is further configured to, after the specifier has specified the reflective surface used to scan the photosensitive member, set the masking period, when the detector has detected the timing indicating that the light-receiving unit has received the light reflected by the reflective surface specified by the specifier unit, to a period obtained by subtracting a predetermined margin from the period corresponding to the reflective surface specified by the specifier unit.

10. The information processing apparatus according to claim 8,
wherein the detector is further configured to, until the specifier specifies the reflective surface used to scan the photosensitive member, set the masking period based on the shortest period among the periods indicated by the period information.

11. The information processing apparatus according to claim 9,
wherein the predetermined margin is set based on a jitter amount in a rotation of the rotating polygonal mirror.

12. The information processing apparatus according to claim 8,
wherein the specifier is further configured to specify the reflective surface used to scan the photosensitive member based on a period between two timings and the period information, the period between two timings being indicated by the timing signal and being adjacent with respect to time.

13. An information processing apparatus connected to an image forming apparatus including an image forming unit, the image forming unit comprising:
a first receiver configured to receive image data;
a photosensitive member;
a light source configured to emit light based on the image data received by the first receiver;
a rotating polygonal mirror, having a plurality of reflective surfaces that reflect the light emitted by the light source, configured to scan the photosensitive member by being rotationally driven to deflect the light; and
a light-receiving unit configured to receive the light reflected by the rotating polygonal mirror and output a timing signal indicating a timing at which the light is received, and
the information processing apparatus comprising:
a second receiver configured to receive the timing signal;
a plurality of detectors, each provided corresponding to one of the plurality of reflective surfaces, and into each of which the timing signal is input;
a specifier configured to specify a reflective surface used to scan the photosensitive member based on results of detecting the timing of the timing signal by the plurality of detectors;
a corrector configured to correct image data corresponding to each of a plurality of scanning lines constituting an image equivalent to one surface's worth of a recording medium, using correction data corresponding to the reflective surface corresponding to each scanning line; and
an output unit configured to output the image data corrected by the corrector to the image forming unit in response to the plurality of detectors detecting the timing,
wherein each of the plurality of detectors masks a detection of the timing during a masking period after at least one of the plurality of detectors has detected the timing;
each of the plurality of detectors is configured to set the masking period based on a period corresponding to the reflective surface corresponding to that detector; and
the period corresponding to the reflective surface is a period from when the light reflected by the reflective surface is received by the light-receiving unit to when the light reflected by the next reflective surface is received by the light-receiving unit.

14. The information processing apparatus according to claim 13,
wherein each of the plurality of detectors is further configured to detect the timing during a detection period from when the masking period has passed.

15. The information processing apparatus according to claim 14,
wherein the detection period is set on the basis of a jitter amount in a rotation of the rotating polygonal mirror.

16. An image forming apparatus comprising a generation unit configured to generate image data and an image forming unit configured to form an image on a recording medium based on the image data output by the generation unit,
the image forming unit comprising:
a first receiver configured to receive the image data;
a photosensitive member;
a light source configured to emit light based on the image data received by the first receiver;
a rotating polygonal mirror, having a plurality of reflective surfaces that reflect the light emitted by the light source, configured to scan the photosensitive member by being rotationally driven to deflect the light; and
a light-receiving unit configured to receive the light reflected by the rotating polygonal mirror and output a predetermined signal having a first level and a second level in response to a reception of the light, and
the generation unit comprising:
a second receiver configured to receive the predetermined signal;
a detectro configured to detect a change from the first level to the second level in the predetermined signal received by the second receiver;
a specifier configured to specify a reflective surface, among the plurality of reflective surfaces, used to scan the photosensitive member, based on a timing at which the change is detected by the detector;
a corrector configured to correct image data corresponding to each of a plurality of scanning lines constituting an image equivalent to one surface's worth of a recording medium, using correction data corresponding to the reflective surface corresponding to each scanning line; and
an output unit configured to output the image data corrected by the corrector to the image forming unit in response to the detector detecting the change,
wherein the detector is further configured to, in a period until the specifier specifies the reflective surface, detect the change after a predetermined amount of time has passed after the change has been detected, and after the specifier has specified the reflective surface, detect the change after an amount of time based on the specified reflective surface has passed after the change has been detected.

17. An image forming apparatus comprising a generation unit configured to generate image data and an image forming unit configured to form an image on a recording medium based on the image data output by the generation unit,
the image forming unit comprising:
a first receiver configured to receive the image data;
a photosensitive member;
a light source configured to emit light based on the image data received by the first receiver;
a rotating polygonal mirror, having a plurality of reflective surfaces that reflect the light emitted by the light source, configured to scan the photosensitive member by being rotationally driven to deflect the light; and
a light-receiving unit configured to receive the light reflected by the rotating polygonal mirror and output a timing signal indicating a timing at which the light is received, and
the generation unit comprising:
a second receiver configured to receive the timing signal;
a detector configured to detect the timing indicated by the timing signal;
a holding unit configured to hold period information indicating a period based on each of the plurality of reflective surfaces, the period based on a reflective surface being a period from when the light reflected by the reflective surface is received by the light-receiving unit to when the light reflected by the next reflective surface is received by the light-receiving unit;
a specifier configured to specify the reflective surface, among the plurality of reflective surfaces, used to scan the photosensitive member;
a corrector configured to correct image data corresponding to each of a plurality of scanning lines constituting an image equivalent to one surface's worth of a recording medium, using correction data corresponding to the reflective surface corresponding to each scanning line; and
an output unit configured to output the image data corrected by the corrector to the image forming unit in response to the detector detecting the timing,
wherein the detector is further configured to mask a detection of the timing signal during a masking period following the detection of the timing; and
the detector is further configured to, after the specifier has specified the reflective surface used to scan the photosensitive member, set the masking period, when the detector has detected the timing indicating that the light-receiving unit has received the light reflected by the reflective surface specified by the specifier, based on a period corresponding to the reflective surface specified by the specifier.

18. An image forming apparatus comprising a generation unit configured to generate image data and an image forming unit configured to form an image on a recording medium based on the image data output by the generation unit, the image forming unit comprising:
a first receiver configured to receive the image data;
a photosensitive member;
a light source configured to emit light based on the image data received by the first receiver;
a rotating polygonal mirror, having a plurality of reflective surfaces that reflect the light emitted by the light source, configured to scan the photosensitive member by being rotationally driven to deflect the light; and
a light-receiving unit configured to receive the light reflected by the rotating polygonal mirror and output a timing signal indicating a timing at which the light is received, and
the generation unit comprising:
a second receiver configured to receive the timing signal;
a plurality of detectors, each provided corresponding to one of the plurality of reflective surfaces, and into each of which the timing signal is input;
a specifier configured to specify a reflective surface used to scan the photosensitive member based on results of detecting the timing of the timing signal by the plurality of detectors;
a corrector configured to correct image data corresponding to each of a plurality of scanning lines constituting an image equivalent to one surface's worth of a recording medium, using correction data corresponding to the reflective surface corresponding to each scanning line; and
an output unit configured to output the image data corrected by the corrector to the image forming unit in response to the plurality of detectors detecting the timing,
wherein each of the plurality of detectors masks a detection of the timing during a masking period after at least one of the plurality of detectors has detected the timing;
each of the plurality of detectors is configured to set the masking period based on a period corresponding to the reflective surface corresponding to that detector; and
the period corresponding to the reflective surface is a period from when the light reflected by the reflective surface is received by the light-receiving unit to when the light reflected by the next reflective surface is received by the light-receiving unit.
